(19) United States
(12) Patent Application Publication
(10) Pub. No.: US 2011/0023709 A1
(43) Pub. Date: Feb. 3, 2011

(54) DUST COLLECTOR CONTROL SYSTEM

(76) Inventor: Robert G. Bosshard, Kurrajong (AU)

Correspondence Address: MEYERTONS, HOOD, KIVLIN, KOWERT & GOETZEL, P.C., P.O. BOX 398, AUSTIN, TX, 78767-0398, US

(21) Appl. No.: 12/851,351

(22) Filed: Aug. 5, 2010

Related U.S. Application Data
(63) Continuation-in-part of application No. PCT/AU2009/000137, filed on Feb. 5, 2009.

(30) Foreign Application Priority Data
Feb. 5, 2008 (AU) 2008900515

(51) Int. Cl. B01D 46/46

(52) U.S. Cl. 95/19; 95/278; 96/417; 96/421; 96/397; 95/1; 96/399; 96/400

(57) ABSTRACT

System for a dust filter unit includes dust detector to measure dust concentration in an outlet conduit of the filter unit. A controller establishes the detected dust concentration following a cleaning cycle of a filter of the unit and in one form compares that detected concentration to a baseline concentration to identify whether there is possible leak in the filter. The system also includes monitoring arrangements to measure pressure profiles in the unit to assess the state of values and/or filters in the unit. Methods of detecting the state of a filter unit are also described.

### PRIORITY CLAIM

This application is a Continuation-in-Part of PCT Patent Application No. PCT/AU2009/000137 entitled “DUST COLLECTOR CONTROL SYSTEM” filed on Feb. 5, 2009, which claims the benefit of Australian Patent Application No. 2008900515 filed on Feb. 5, 2008.

### BACKGROUND OF THE INVENTION

1. Field of the Invention

The present invention relates to air filtration systems and in particular to dust collectors and to monitor and control systems for dust collectors.

2. Description of the Relevant Art

Dust collectors are used by a variety of industries such as mining, pharmaceutical, power industry, sawmills, small to large workshops (i.e. schools, hospitals, art gallery), furniture manufacturers, cement, chemical, food industries and such. Historically, filtering of air on commercial premises was done using scrubbers and precipitators. These filters have been more suitable in high temperature plants. Dust collectors may employ the use of either tubular filter bags or cartridges to retain fine dust particles. One popular type of filter is made from fabric. Fabric filters have higher efficiency in dust collection and clean air emissions compared to other filter types. Dust collectors operate like giant vacuum cleaners with a number of collection bags, called baghouses. Dust particles are drawn into fabric bag filters and trapped by the walls of the filter bag.

For the bags to filter at an optimal level they must be cleaned regularly. In order to provide continuous filtered air, dust particles trapped by the filters need to be removed whilst the plant is operating. In one method, this is achieved by periodical shaking of the filters. The filters are shaken either mechanically (for example, between every 5 to 15 seconds) or blasted with compressed air. The dust particles then fall from the filters and are collected below in a hopper which is regularly emptied. Too much shaking is to be avoided where possible as it can cause unnecessary wear to the filters.

### SUMMARY OF THE INVENTION

According to a first embodiment there is provided a method of determining a state of a dust filter unit having an air inlet conduit for directing air to be filtered to a filter and an air outlet conduit for receiving filtered air from the filter, the air to be filtered being caused to flow from the inlet to the outlet through the filter and wherein the filter is subjected to cleaning cycles, the method includes:
detecting the concentration of dust in the outlet conduit following one of the cleaning cycles of the filter, the detected concentration of dust being indicative of the state of the dust filter unit.

In one form, the method includes, after the detecting step, of comparing the detected concentration of dust with a baseline dust concentration, wherein a detected dust concentration which is greater than the baseline dust concentration indicates a possible leak in the dust filter. In a particular embodiment, the comparing step may be performed within a predetermined time after the cleaning of the filter. Alternatively, the comparing step may be performed after the cleaning cycle within a predetermined percentage of time of a single complete cleaning cycle.

In one form, the cleaning cycle includes forcing air through the filter, opposite the direction of flow of air to be filtered, for a predetermined time period or until a predetermined volume of air has passed through the filter. In a particular form, the step of forcing air through the filter includes forcing the air through the filter as a pulse of air at a pressure higher than the pressure of air flowing through the filter from the inlet conduit to the outlet conduit.

The cleaning cycle may include shaking the filter.

In one form, the filter unit may include a plurality of filters and the method is employed to detect a leak in at least one of the filters or one filter in a group of filters. The filter unit may also include an outlet manifold, wherein the or each filter is connected to the manifold and the outlet conduit is in fluid communication with the manifold. In one form, the filter unit may include a plurality of said outlet manifolds, each manifold having at least one of said filters connected thereto and being in communication with the outlet conduit. The detecting step may be applied to each respective manifold at different times. Optionally, the method may be employed to detect a leak in at least one filter of a group of filters connected to one of the manifolds.

In a particular form, the or each filter is a bag filter or cartridge filter.

In one form, when a leak is detected in the filter unit, the flow of air through the filter is stopped.

In one form, there is provided the further step of establishing the differential in air pressure across the filter to indicate a further state of the dust filter unit. In a particular form the differential in air pressure is indicative of whether the filter requires cleaning.

In a further aspect, there is provided a method of determining a state of a dust filter unit having an air inlet conduit for directing air to be filtered to a filter and an air outlet conduit for receiving filtered air from the filter, the air to be filtered being caused to flow from the inlet to the outlet through the filter and wherein the filter is subjected to cleaning cycles, the method includes:
establishing the differential in air pressure across the filter to indicate the state of the dust filter unit.

In a particular form, a characteristic of the cleaning cycle is established utilizing the established differential in air pressure across the filter. The characteristic of the cleaning cycle may be the duration of the cycle, the strength of the cycle and/or the timing of the activation of the cleaning cycle.

In a particular form, where the characteristic is the timing of the activation of the cleaning cycle, the cleaning cycle is activated when the established differential is above a predetermined threshold.

According to a further embodiment there is provided a monitoring system for a dust filter unit, the unit including an air inlet conduit for directing air to be filtered to a filter and an air outlet conduit for receiving filtered air from the filter, the air to be filtered being caused to flow from the inlet to the outlet through the filter and wherein the filter is subjected to cleaning cycles, the system including:
a dust detector configured to be associated with and for detecting a concentration of dust in the outlet conduit; and
a controller configured to identify the detected dust concentration following one of the cleaning cycles such that the detected concentration of dust can be compared with a baseline dust concentration.

In one form, the system further includes a comparator module arranged to compare the detected concentration with the baseline concentration so as to determine the state of the filter unit; and an output module arranged to issue an alert signal responsive to the comparator module determining that the state of the filter unit is exhibiting one or more characteristics.

In one form the one or more characteristics includes a possible leak in the filter.

In yet a further aspect, there is provided a control system for a dust filter unit, the unit including an air inlet conduit for directing air to be filtered to a filter and an air outlet conduit for receiving filtered air from the filter, the air to be filtered being caused to flow from the inlet to the outlet through the filter and wherein the filter is subjected to cleaning cycles, the system including:
a device for detecting the differential in air pressure across the filter; and
a controller operable to control one or more characteristics of the cleaning cycle in response to the differential in air pressure being at a threshold level.

According to a fourth embodiment there is provided a method of detecting a leak in a dust filter unit having an air inlet conduit for directing air to be filtered to a filter and an air outlet conduit for receiving filtered air from the filter, the air to be filtered being caused to flow from the inlet to the outlet through the filter and wherein the filter is subjected to cleaning cycles, the method including:
performing a cleaning cycle by agitating the filter to dislodge at least some of the residue therefrom;
stopping the agitation step;
after stopping the agitation step, detecting the concentration of dust in the outlet conduit; and
comparing the detected concentration of dust with a baseline dust concentration, wherein a detected dust concentration which is greater than the baseline dust concentration indicates an undesired leak in the dust filter unit.

According to a further embodiment there is provided a method for determining a state of a cleaning cycle system of a dust collector, the dust collector having an air inlet conduit for directing air to be filtered to one or more filters and an air outlet conduit for receiving filtered air from the one or more filters, the air to be filtered being caused to flow from the inlet to the outlet through the one or more filters and wherein the one or more filters are subjected to cleaning cycles by the cleaning cycle system, the cleaning cycle system periodically providing cleaning air from a cleaning air source via a valve system through the one or more filters, the method includes:
measuring a pressure profile of the cleaning air in the cleaning air source during at least a portion of one of the cleaning cycles and comparing the profile against a predetermined profile, wherein a difference of more than a predetermined amount between the cleaning air pressure profile and the predetermined profile indicates a changed state of the cleaning cycle system.

In one form, the changed state includes an undesired condition of one or more of the valves of the valve system. Optionally, the underside may include a failure of one or more of the valves to open or to close. The difference may be determined by the difference between the gradient of the predetermined profile and the gradient of the cleaning air pressure profile.

In a particular form, the cleaning air source includes an air receiver and the step of measuring the cleaning air pressure profile includes measuring the cleaning air pressure profile of the air in the air receiver.

According to another embodiment there is provided a system for determining a state of a cleaning cycle system of a dust collector, the dust collector having an air inlet conduit for directing air to be filtered to one or more filters and an air outlet conduit for receiving filtered air from the one or more filters, the air to be filtered being caused to flow from the inlet to the outlet through the one or more filters and wherein the one or more filters are subjected to cleaning cycles by the cleaning cycle system, the cleaning cycle system periodically providing cleaning air from a cleaning air source via a valve system through the one or more filters, the system including:
a valve between the cleaning air source and the dust collector, the valve being operable to provide cleaning air to the one or more filters;
a pressure measuring device for measuring the pressure over time in the cleaning air source;
a device for determining a pressure profile of the cleaning air in the cleaning air source during at least a portion of one of the cleaning cycles; and
a device for comparing the cleaning air pressure profile against a predetermined profile, wherein a difference of more than a predetermined amount between the cleaning air pressure profile and the predetermined profile indicates a changed state of the cleaning cycle system.

In one form, the system includes a controller for controlling the cleaning cycle system and the valve. The cleaning air source may include an air receiver.

In a particular form, when a difference of more than the predetermined amount is detected, the cleaning cycle system is interrupted. Also, when a difference of more than the predetermined amount is detected, an alarm may be activated.

In one form, the controller is connected to and remotely accessible via a computer network. The controller may be in communication with the computer network via the Internet.

According to yet a further embodiment a method is provided for controlling a cleaning cycle of a dust filter system including one or more filters, the cleaning cycle having start and stop criterion associated with a characteristic of the dust filter system, the method including:
adjusting at least one of the start and stop criteria in response to a predefined state of the dust filter system being determined.

In one form the characteristic for at least one of the start and stop criterion is a pressure differential detected across one or more filters of the dust filter system.

In one form the start criterion is that the pressure differential across the one or more filters has reached a first predefined value. In one form the stop criterion is that the pressure differential across the one or more filters has fallen below a second predefined value which is lower than the first predefined value.

In one form a value of at least one of the start and stop pressure criterion is adjusted in response to a duration of a previous or current cleaning cycle exceeding a predefined value.

In one form a value of at least one of the start and stop pressure criterion is adjusted in response to determining that at least one filter of the filter system has reached a predefined age and/or filtration state.

In one form, in response to adjusting the value of the stop criterion when the duration of the current cleaning cycle exceeds a predefined value, the value of the start criterion is adjusted by a predefined amount.

In one form the value of at least one of the start and stop criterion is increased by a fixed amount. In another form the values of at least one of the start and stop criterion is increased by an amount dependent on at least one of: an age of the filter(s); a state of the filter(s); a particulate size of the filtered material; and a system loading.

In yet a further embodiment a controller is provided for a dust filter system including one or more filters, the controller being arranged to implement a cleaning cycle having start and stop criterion associated with a characteristic of the dust filter system, the controller being further arranged to adjust at least one of the start and stop criteria in response to determining a predefined state of the dust filter system.

In one form the characteristic for at least one of the start and stop criterion is a pressure differential detected across one or more filters of the dust filter system.

In one form the start criterion is that the pressure differential has reached a first predefined value. In one form the stop criterion is that the pressure differential has fallen below a second predefined value which is lower than the first predefined value.

In one form the controller is arranged to adjust a value of at least one of the start and stop criterion in response to determining that a duration of a previous or current cleaning cycle exceeds a predefined value.

In one form a value of at least one of the start and stop criterion is adjusted by the controller in response to determining that the one or more filters has reached a predefined age and/or filtration state.

In one form, in response to the value of the stop criterion being adjusted, the controller is further arranged to adjust the value of the start criterion by a corresponding amount.

In one form the value of at least one of the start and stop criterion is increased by a fixed amount.

In one form the values of the start and stop criterion are adjusted by an amount dependent on at least one of: an age of the filter(s); a state of the filter(s); a particulate size of the filtered material; and a system loading.

In yet a further embodiment a controller is provided for a dust filter system including at least one dust filter, the controller being arranged to implement a plurality of cleaning cycles over a period of time, the cleaning cycles having start and stop threshold values associated with a characteristic of the dust filter system, the controller being further arranged to incrementally increase the respective start and stop threshold values over the period of time.

In one form the controller is arranged to implement each incremental increase in response to a predefined state of the filter system being determined.

In one form the predefined state is that the duration of a current or previous cleaning cycle has exceeded a predefined value. In one form the characteristic is the pressure differential measured across one or more of the filters.

According to yet another embodiment, computer program code is provided which when executed by a processor implements the method according to any one of the aforementioned aspects.

According to another embodiment a computer readable medium including the program code of the aforementioned aspect is provided.

According to another embodiment, a data signal carrying the program code of the aforementioned aspect is provided.

### BRIEF DESCRIPTION OF THE DRAWINGS

Preferred embodiments of the invention will now be described, by way of example only, with reference to the accompanying drawings in which:

FIG. 1 is a sectional side elevation of a dust control system according to an embodiment;

FIG. 2 is a schematic illustration of a dust control system according to an embodiment;

FIG. 2A is a schematic of a controller in accordance with an embodiment;

FIGS. 3a-c illustrate simplified theoretical graphical representations of header air receiver pressure profiles under different valve fault conditions; and

FIG. 4 is a table illustrating an on-demand cleaning cycle implemented by the controller of FIG. 2A.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

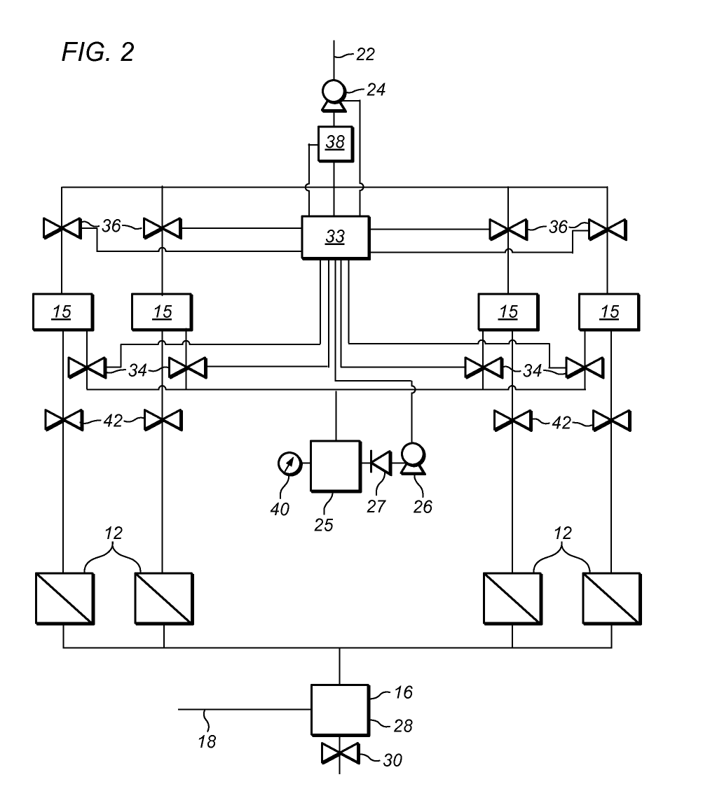

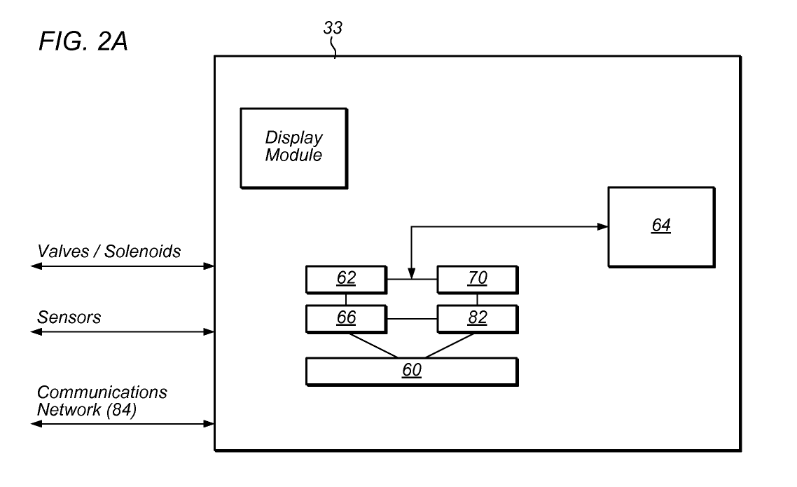

Referring to the figures, a preferred embodiment includes a dust filter monitoring/control system. In this embodiment, the system includes one or more dust filter units 10 of the type which includes a plurality of banks 12 of filters in the form of filter bags 14, preferably fabric filter bags 14. Each bank 12 includes five filter bags 14, although in alternative embodiments, different respective banks may include more or fewer filter bags 14. Also in this embodiment, as illustrated in FIG. 2, there are four banks 12, but in alternative embodiments there may be more or fewer than four banks 12. The number of banks and/or filter bags employed will depend on the quality and/or volume of the air to be filtered.

Each bank 12 includes a respective outlet manifold 15 on which the filter bags 14 are held. The manifolds 15 are sealingly connected to a hopper 16, in such a manner that the filter bags 14 are contained within a sealed chamber defined by the manifolds 15 and the hopper 16. An air inlet 18 is in fluid communication with the hopper 16 to provide air to be cleaned to the filter bags 14. Each manifold 15 is in turn in fluid communication with a clean air outlet conduit 22. A fan 24 is operatively connected to the outlet conduit 22 to draw air from the inlet 18 through the filter bags 14 and manifolds 15 to the outlet conduit 22.

Each bank 12 of filter bags 14 is cleaned periodically (or on demand, as described in more detail in subsequent paragraphs) in a cleaning cycle by providing a burst of relatively higher pressure air from a header air receiver 25, the air of which is supplied to the air receiver 25 by a compressor 26 via a non-return valve 27. A burst of air is provided from the air receiver 25 through the filter bags 14 in a direction opposite to the filtration direction of flow of the air at a pressure higher than the pressure of the air being drawn through the filters. This results in dislodging residue from the filters into a collection chamber 28 at the bottom of the hopper 16. The collection chamber 28 can be manually emptied for disposal of the residue. Also in this embodiment, there is a sensor 32 in the collection chamber which determines when the volume of residue in the collection chamber 28 reaches a predetermined amount. An alarm may then be activated to inform a supervisor that the chamber 28 needs to be emptied. Alternatively, emptying of the chamber 28 may be automated using an auger which feeds the collected duct from the hopper to a removal conveyor.

The filtration system is provided with a controller 33 which is configured to provide several functions. One function is to arrange the cleaning of the filter bags 14. With additional reference to FIG. 2A, the controller 33 includes a microprocessor 60 which implements a valve control module 62 programmed to control various pulse inlet and manifold valves (e.g. by way of various solenoids or the like) for affecting a cleaning cycle. In one embodiment this involves controlling operation of pulse inlet valves 34 and manifold valves 36, based on program code stored in memory 64. In the illustrated embodiment, each manifold 15 has one of said pulse inlet valves 34 and one of said manifold valves 36 associated therewith. To perform a cleaning function, the manifold valves 36 are actuated to close and the pulse inlet valves 34 are actuated to open on command of the controller 33. This forces a pulse of air back through the filter bags 14 as described above. In practice, it is often desirable to continue the filtration process, regardless of the cleaning of the filter bags 14. Therefore, in this embodiment, the controller 33 is configured to allow for the cleaning of one bank 12 of filter bags 14 at a time to allow the remaining banks 12 to continue filtering. This is achieved using a staged sequential, scheduled, or ad hoc cleaning cycle or by a cleaning cycle that is activated in response to a state of the filters. In alternative embodiments, depending on the requirements of the user of the filtration system, all or more than one bank of filter bags may be cleaned at once.

In this embodiment, it is possible to monitor the filter unit to determine states of the dust filter unit 10, one state to be determined in this embodiment being the integrity of the filter bags 14, another being whether the bags require cleaning.

In determining the integrity of the bags, it is possible to determine whether one or more of the banks 12 contain one or more broken or damaged or otherwise non-integral filter bags 14. This is achieved by the use of a dust particle monitor 38 located in the outlet conduit 22. In this embodiment, the dust particle monitor 38 detects the concentration of dust particles in the outlet conduit 22 during cleaning and filtration of the air and communicates the readings to a comparator module 66 implemented by the controller 33, for subsequent analysis. The comparator module 66 then compares the readings to a baseline concentration stored in memory 64, the baseline concentration being the desired maximum concentration of particulate matter in the filtered air. If the comparator module 66 detects a concentration of dust particles above the baseline level, and in particular above a predetermined percentage tolerance above the baseline level, it is assumed at least one filter bag 14 has an undesirable leak. For example, the baseline level may be 99.9% removal of all particulate matter having a mean particle diameter of 1 μm from the air by the unit 10. Also, the predetermined tolerance may be 0.9%, such that if the comparator module 66 determines that less than 99% of particulate matter is removed from the air by the unit 10, then it is deemed that one of the filter bags 14 has a leak.

The inventor has recognised that when a filter bag has a leak, the leak may be blocked by filtered residue that has built up over time thus reducing the amount of undesired particulate matter passing through the filter, sometimes to a level which is difficult to accurately detect. However, immediately after a cleaning cycle, the residue blocking the undesirable leak is removed and the amount of undesirable particulate matter passing through the leaking filter is subsequently increased until residue again builds upon the undesirable leak point. Therefore, it has been determined that the preferred time to compare the amount of particulate matter with the baseline concentration for a given bank 12 is immediately after a cleaning cycle has been performed on the given bank 12 of filter bags 14, given that it is generally easier to detect undesired particulate matter in the outlet conduit 22 at that time. Also, given that the cleaning of each bank 12 is sequential, if an increase in particulate matter is detected by the comparator module 66 immediately after the cleaning of one particular bank, then it can be assumed that at least one of the filter bags 14 in the cleaned bank 12 has an undesired leak. A supervisor or other delegated person can then stop filtration through the bank 12 detected to contain the leaking filter bag to check the bags of the bank 12 and replace or repair the non-integral or damaged filter.

Alternatively, on detection of a leak, an automated system employing the controller 33 can be employed to stop filtration through the bank 12 which contains the leaking filter bag. In an embodiment, this is achieved by way of the valve control module 62 which is additionally operable to close a valve 42 on the filtered air side of the bank 12 with the damaged filter bag, again based on program code stored in memory 64. In this way, the dust filter unit 10 can continue to filter the incoming air through the remaining operating banks 12. The bank 12 with the damaged filter bag(s) may then be isolated and visually inspected for damage. As will be understood, this is particularly useful when attempting to locate a fault or leak in one filter bag 14 in systems which employ the use of hundreds or thousands of filter bags 14 in one or more units 10. Also, this embodiment has the advantage that only one dust particle monitor 38 is required for each unit 10, reducing capital and operating costs.

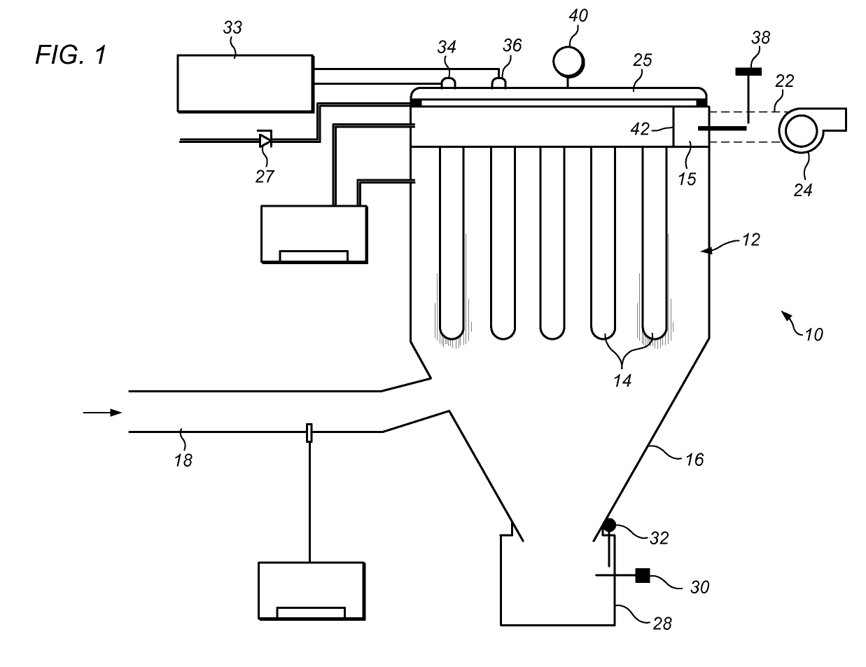

In an embodiment the controller 33 also communicates with a pressure sensor 50 to determine the pressure differential across the filter bags at any given time. The pressure differential may be used by the controller 33 to determine when and how best to control a cleaning cycle. For the setup illustrated in FIG. 1, the pressure differential may, for example, range from between 0-2.5 KPa, depending on the state and age of the filter bags. The pressure differential readings can then be communicated to a pressure control module 70 implemented by the controller 33 which utilises the readings to control characteristics of the cleaning cycle, such as the timing of the activation of the cleaning cycle (i.e. for on demand cleaning), its duration and/or its strength. The advantage of such a system is that the life of the bags may be extended by reducing the need for unnecessary cleaning, and can improve performance of the system. Where the on demand cleaning option has been enabled (i.e. as opposed to the periodically controlled option), the pressure control module 70 may be configured to activate a cleaning cycle in response to some predefined start criterion associated with a characteristic of the filter system being met. For example, the criterion may be that a predefined pressure differential threshold has been exceeded. The predefined pressure differential threshold may be set at a level which is indicative that the filter bags 14 are clogged and are in need of cleaning. For example, the pressure control module 70 may be programmed to compare a current pressure differential reading received from the pressure sensor 50 to a first threshold pressure level which is stored in memory 64. The controller 33 will then initiate a cleaning cycle which will continue until a stop criterion associated with a system characteristic has been met. The stop criterion may, for example, be that the pressure differential falls below a second threshold pressure level (also stored in memory 64) which is indicative that the bags are sufficiently clean to continue filtering. It will be understood by persons skilled in the art, however, that the system characteristic may be other than the pressure differential. For example, the characteristic may be operational time, filter state, etc.

It will be appreciated that during high use periods, where the particulate levels present in the incoming air are particularly high, the pressure differential measured by the pressure control module 70 may rise sharply and in turn quickly surpass the first threshold pressure level 92. In such situations a normal cleaning cycle may not be sufficient to bring the pressure differential down in a suitable timeframe. To accommodate for such high use periods, a third threshold level which is higher than that of the first threshold level may be programmed into the pressure control module 70 and which, once exceeded, causes the controller 33 to implement an intensive cleaning cycle. In an embodiment, the intensive cleaning cycle may pulse more frequently than a standard cleaning cycle (as previously described) and/or have an increased pulsing pressure. Other variations which increase the effective cleaning capability are envisaged and should not be seen as limited to those variants described above.

The present inventor has recognised that, by virtue of their construction, certain filter bags 14 may, over time, increasingly retain particulates after each cleaning cycle. Thus, irrespective of how many or how often the cleaning cycles are implemented by the controller 33, the differential pressure of the system will gradually rise and the thresholds described above for such filter bags may no longer be appropriate. For example, if the thresholds remained constant for such systems the differential pressure for the system would gradually reach a point where the cleaning cycle would be continually “on” (i.e. pulsing is continuous) which would cause the filter bags to wear prematurely and thus defeat the on demand cleaning feature, as previously described. To avoid such a situation, the pressure control module 70 may, in an embodiment, advantageously implement dynamic thresholds which increase in value over the life of the bags.

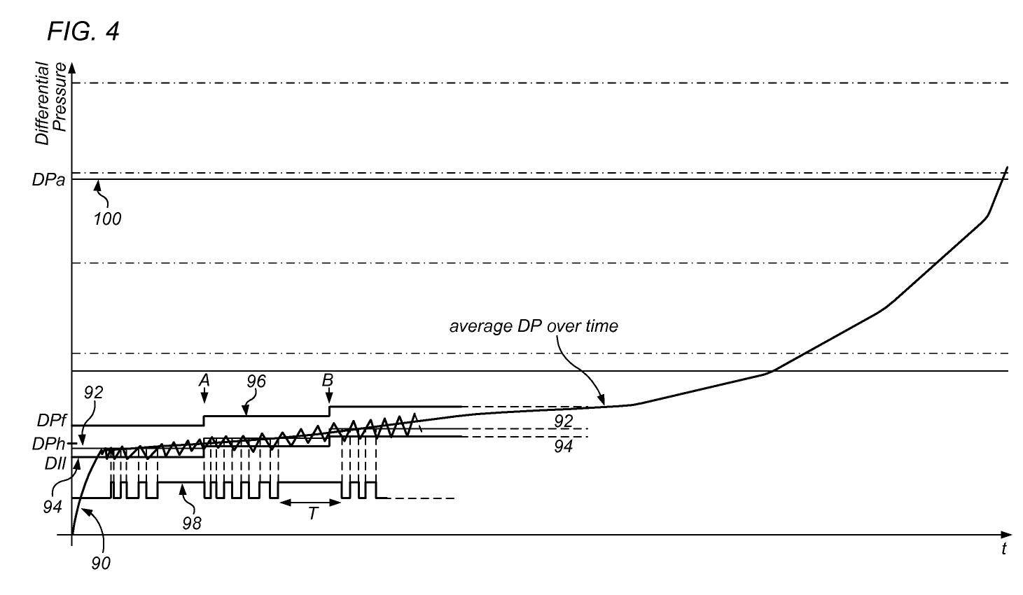

In an embodiment the dynamic thresholds may be set to increase when the pressure control module 70 determines that the cleaning cycle has been continually on for a period of time T which is greater than some predefined time period stored in memory. For example, if the system has been continuously pulsing for greater than two hours, then the pressure control module 70 may increase the second threshold (being the pressure level at which the cleaning cycle is stopped) such that it meets or exceeds the current system differential pressure. The first and third thresholds may at the same time be increased by a corresponding amount. It will, of course, be appreciated that the continuous pulsing time which triggers the adjustment in threshold value may be more or less than two hours depending on the actual implementation (i.e. type of filters being used, particle size, etc.). In an embodiment the stage and/or age of the filter bags 14 may additionally, or alternatively, be taken into consideration by the pressure control module 70 when determining when and by how much to increase the thresholds. In an embodiment the timing and/or amount by which the thresholds are increased may also be dependent on various system parameters such as the type of filter bags 14, the size of the particulates being filtered by the system as well as any other relevant system parameters. In another embodiment, the amount by which the thresholds is increased is a predefined fixed amount. Such a stepped increase in threshold levels is shown in FIG. 4. According to FIG. 4, the measured pressure differential is designated by reference numeral 90, while the first, second and third pressure differential levels are designated by reference numerals 92, 94 and 96 respectively. The pulsing intervals for a cleaning cycle are also shown and designated by reference numeral 98. The pressure control module 70 may continue to increase the thresholds until the first threshold level is within some distance of an alarm pressure differential level 100 (e.g. the first threshold level has reached 90% of the alarm level). At this point the pressure control module 70 may be configured to issue an appropriate warning (e.g. audible or visible alarm) to an operator that the filter bags 14 need to be changed.

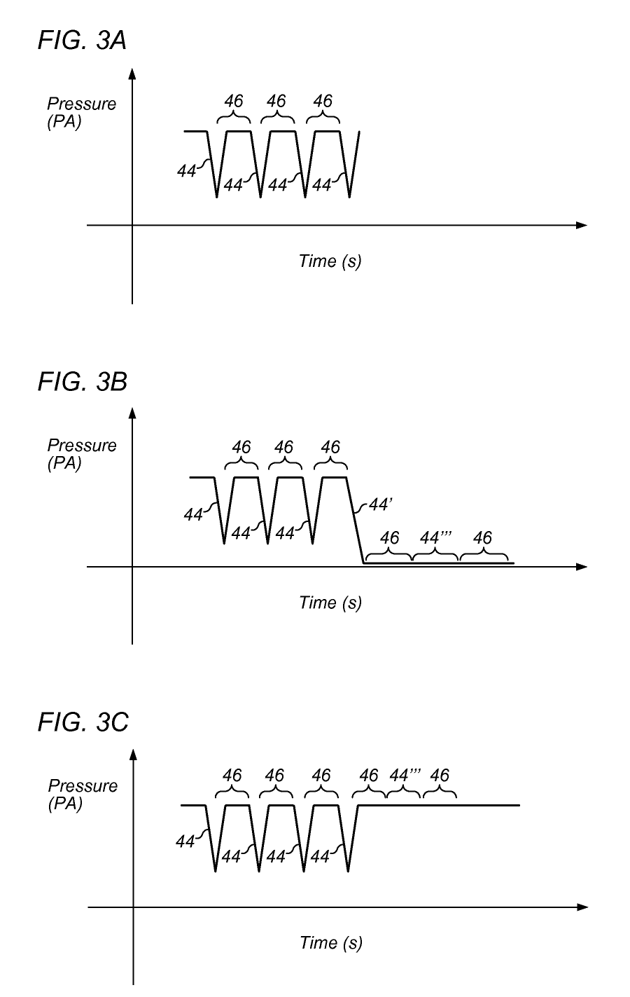

In another embodiment, which may be used in conjunction with or separately to the above described embodiments, the state to be determined by the controller 33 is whether one or more of the pulse inlet valves 34 are undesirably stuck open or closed. This may occur due to a mechanical fault, such as build up of dust at the valve not allowing it to open or close, or an electrical fault, for example where an electrical connection operatively engaged with the valve in question has short circuited. This state is determined by measuring a pressure profile of the air pressure in the air receiver 25 during a cleaning cycle using pressure transducer 40, which is in communication with the pressure control module 70. This air pressure is much higher than that detected across the filters and is typically in the order of 550-800 KPa. As will be understood, the measured profile during a cleaning cycle should decrease with time, as illustrated in FIG. 3a, where the air pressure during a cleaning cycle is denoted as 44 and the air pressure between cleaning cycles is denoted as 46. The pressure rises between cleaning cycles as air is supplied by the compressor 26 to the air receiver 25. The pressure control module 70 monitors the air pressure in the receiver 25 and is operable to stop air supply to the air receiver 25 once the pressure reaches a predetermined maximum pressure. The pressure profile 44 of the change in pressure in the air receiver 25 during a cleaning cycle may be taken as a predetermined or desired pressure profile (i.e. stored in memory 64), indicating that the cleaning system valves (34) are working as expected.

Referring to FIG. 3b, if a pulse air inlet valve 34 opens during one cleaning cycle (44′) and fails to close, the gradient of the air pressure profile (44″) of the following cleaning cycle will be relatively flatter, since the starting pressure will be lower due to leaking of the cleaning air through the pulse inlet valve 34. While the pressure control module 70 notes that the air pressure in the air receiver 25 is too low and so directs the air compressor 26 to continue to supply air to the receiver, the open pulse air inlet valve 34 continues to leak air, and thus the pressure either falls (as illustrated in FIG. 3b), will remain unchanging, or will rise slightly over time, depending on by how much the valve 34 is open. Therefore, there is a difference between the desired pressure profile indicated as 44 in FIG. 3a and the measured pressure profile indicated by 44″ in FIG. 3b. This indicates a failure of the valve 34 to close.

Similarly, referring to FIG. 3c, if the pulse air inlet valve 34 fails to open, there would be no drop in pressure during the succeeding cleaning cycles, and the pressure profile would resemble the profile indicated by 44″' in FIG. 3c. Again, there will be a difference between the desired pressure profile indicated as 46 in FIG. 3a and the measured pressure profile indicated by 44″′ in FIG. 3c. This would indicate a failure of the valve 34 to open. The absolute value of the pressure indicates whether the failure is due to the valve not opening or not closing. For example, comparing the pressure profiles in FIGS. 3b and 3c where the valves 34 have failed to close and open respectively, the air pressure of the air receiver 25 with the closed valve is relatively higher than the air pressure of the air receiver 25 with the open valve. As will be understood, if any one of the pulse inlet valves 34 is stuck fully open or closed, this is an extreme fault situation.

If any of the pulse air inlet valves 34 are determined to be stuck open or closed, they are first tested to determine if they are stuck open or closed by an electrical fault. In this embodiment, a test module implemented by the controller 33 is operable to supply an electrical current to each valve 34 at fault. If the current is above a predetermined level, it is implied that there is an undesired short circuit across the valve. If the current is below a predetermined amount, or zero, it is implied that there is an undesired open circuit across the valve. If no open or short circuit is detected, it is implied that the fault with the valve(s) 34 in question is a mechanical fault. The valve can then be isolated and visually inspected. Any visually detected obstructions (eg dust build up) can then be removed, or the faulty valve repaired or replaced as needed.

While the present embodiment applies to cleaning units 10 which are monitored by an on-site supervisor, in another embodiment, being a variation on each of the above described embodiments, the controller 33 is remotely accessible by a computer via the Internet, or some other suitable communications network. In this way, the operation of the dust filter units 10 can be monitored and/or controlled off site. For example, if it is determined that the cleaning cycle needs to be modified a control signal could be sent to the control module 33 which causes the cleaning cycle program code stored in memory 64 to be suitably modified. In the embodiment illustrated in FIG. 2A, the controller 33 includes a modem 82 for communicating with the remote computer across a secured private network denoted by reference number 84.

As will be understood, unless the context requires or suggests otherwise, features of any one of the above described embodiments may be used in conjunction with another one or more of the above described embodiments.

While the invention has been described in reference to its preferred embodiments, it is to be understood that the words which have been used are words of description rather than limitation and that changes may be made to the invention without departing from its scope as defined by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

A reference herein to prior art information is not an admission that the information forms part of the common general knowledge in the art in Australia or in any other country.

What is claimed is:

1. A method of monitoring for a leak in a dust filter unit having an air inlet conduit for directing air to be filtered to a plurality of filters and an air outlet conduit for receiving filtered air from the filters, the air to be filtered being caused to flow from the inlet to the outlet through the filters and wherein subsets of filters in the filter unit are subjected to separate cleaning cycles, the method comprising:
detecting the concentration of dust in the outlet conduit following a cleaning cycle of the filter unit, and
using the detected concentration of dust to indicate whether one or more of the filters in the subset of filters that have been subjected to that cleaning cycle has a possible leak.

2. The method of claim 1, further comprising, after the detecting step, comparing the detected concentration of dust with a baseline dust concentration, wherein a detected dust concentration which is greater than the baseline dust concentration indicates a possible leak in the one or more filters.

3. The method of claim 1, further comprising establishing the differential in air pressure across the filters to indicate a further state of the dust filter unit.

4. A method of claim 3, wherein the differential in air pressure is indicative of whether the filters require cleaning.

5. The method of claim 3, further comprising establishing a characteristic of a cleaning cycle for a subset of the filters utilizing the established differential in air pressure across those filters.

6. The method of claim 5, wherein the characteristic is the timing of the activation of the cleaning cycle.

7. The method of claim 6, wherein the cleaning cycle is activated when the established differential is above a predetermined threshold.

8. A monitoring system for a dust filter unit, the unit comprising an air inlet conduit for directing air to be filtered to a plurality of filters and an air outlet conduit for receiving filtered air from the filters, the air to be filtered being caused to flow from the inlet to the outlet through the filters and wherein subsets of the filters are subjected to separate cleaning cycles, the system comprising:
a dust detector configured to be associated with and for detecting concentrations of dust in the outlet conduit; and a controller configured to identify the detected dust concentration following respective cleaning cycles such that the detected concentrations of dust can be used in monitoring the states of the subsets of the filters following the respective cleaning cycles.

9. The monitoring system of claim 8, further comprising:
a comparator module arranged to compare a said detected concentration following a cleaning cycle with a baseline concentration so as to monitor the state of the filters in the subsets of filters subjected to that cleaning cycle; and
an output module arranged to issue an alert signal responsive to the comparator module indicates that the state of the filter unit is exhibiting one or more characteristics.

10. The monitoring system of claim 9, wherein the comparator module establishes that the filter includes a possible leak when the detected dust concentration is greater than the baseline dust concentration.

11. The monitoring system of claim 9, further comprising a device for detecting the differential in air pressure across the filters.

12. The monitoring system of claim 11, further comprising a cleaning control module configured to control the cleaning cycle.

13. The monitoring system of claim 12, wherein the control module is operable to activate the cleaning cycle in response to the differential in air pressure being at a threshold level.

14. A method for determining a state of a cleaning cycle system of a dust collector, the dust collector having an air inlet conduit for directing air to be filtered to a plurality of filters and an air outlet conduit for receiving filtered air from the filters, the air to be filtered being caused to flow from the inlet to the outlet through the filters and wherein subsets of the filters are subjected to separate cleaning cycles by the cleaning cycle system through respective valves in a valve system, wherein during the cleaning cycles, the remaining filters continue to filter air between the inlet and the outlet, the cleaning cycle system periodically providing cleaning air from a cleaning air source via the valve system, the method comprising:
measuring a pressure profile of the cleaning air in the cleaning air source during at least a portion of one of the cleaning cycles and comparing the profile against a predetermined profile, wherein a difference of more than a predetermined amount between the cleaning air pressure profile and the predetermined profile indicates a changed state of the cleaning cycle system.

15. The method of claim 14, wherein the changed state comprises an undesired condition of one or more of the valves of the valve system.

16. The method of claim 14, wherein the difference is determined by the difference between the gradient of the predetermined profile and the gradient of the cleaning air pressure profile.

17. A system for determining a state of a cleaning cycle system of a dust collector, the dust collector having an air inlet conduit for directing air to be filtered to a plurality of filters and an air outlet conduit for receiving filtered air from the filters, the air to be filtered being caused to flow from the inlet to the outlet through the filters and wherein subsets of the filters are subjected to separate cleaning cycles by the cleaning cycle system through respective valves in a valve system, wherein during the cleaning cycles, the remaining filters continue to filter air between the inlet and the outlet, the cleaning cycle system periodically providing cleaning air from a cleaning air source via the valve system, the system comprising:
a valve control module operable to allow cleaning air to pass to subsets of the filters via respective valves between the cleaning air source and the dust collector;
a pressure measuring device for measuring the pressure over time in the cleaning air source;
a device for determining a pressure profile of the cleaning air in the cleaning air source during at least a portion of one of the cleaning cycles; and
a comparator module for comparing the cleaning air pressure profile against a predetermined profile, wherein a difference of more than a predetermined amount between the cleaning air pressure profile and the predetermined profile indicates a changed state of the cleaning cycle system.

18. A method of controlling a cleaning cycle of a dust filter system comprising one or more filters, the cleaning cycle having start and stop criterion associated with a characteristic of the dust filter system, the method comprising:
adjusting at least one of the start and stop criteria in response to a predefined state of the dust filter system being determined.

19. The method of claim 18, wherein the characteristic for at least one of the start and stop criterion is a pressure differential detected across the one or more filters.

20. The method of claim 19, wherein the start criterion is that the pressure differential across the one or more filters has reached a first predefined value and the stop criterion is that the pressure differential across the one or more filters has fallen below a second predefined value which is lower than the first predefined value.

21. The method of claim 18, wherein a value of at least one of the start and stop pressure criterion is adjusted in response to a duration of a previous or current cleaning cycle exceeding a predefined value.

22. The method of claim 18, wherein a value of at least one of the start and stop pressure criterion is adjusted in response to determining that the one or more filters have reached a predefined age and/or filtration state.

23. The method of claim 21, wherein in response to adjusting the value of the stop criterion when a duration of the current cleaning cycle exceeds a predefined value, the value of the start criterion is adjusted by a predefined amount.

24. The method of claim 21, wherein the value of at least one of the start and stop criterion is increased by a fixed amount.

25. The method of claim 21, wherein the value of at least one of the start and stop criterion is increased by an amount dependent on at least one of: an age of the filter(s); a state of the filter(s); a particulate size of the filtered material; and a system loading.

26. A controller for a dust filter system comprising one or more filters, the controller being arranged to implement a cleaning cycle having start and stop criterion associated with a characteristic of the dust filter system, the controller being further arranged to adjust at least one of the start and stop criteria in response to determining a predefined state of the dust filter system.

27. The controller of claim 26, wherein the characteristic for at least one of the start and stop criterion is a pressure differential detected across the one or more filters.

28. The controller of claim 26, wherein the start criterion is that the pressure differential has reached a first predefined value and the stop criterion is that the pressure differential has fallen below a second predefined value which is lower than the first predefined value.

29. The controller of claim 26, wherein the controller is arranged to adjust a value of at least one of the start and stop criterion in response to determining that a duration of a previous or current cleaning cycle exceeds a predefined value.

30. The controller of claim 26, wherein, in response to the value of the stop criterion being adjusted, the controller is further arranged to adjust the value of the start criterion by a predefined amount.

31. A computer readable medium comprising computer program code which, when executed by a processor, is arranged to implement the method of claim 18.
